(19) United States
(12) Patent Application Publication
(10) Pub. No.: US 2019/0091826 A1
(43) Pub. Date: Mar. 28, 2019

(54) ABRASIVE FLOW MACHINE

(71) Applicant: Additive Rocket Corporation, La Jolla, CA (US)

(72) Inventors: Kyle Adriany, San Diego, CA (US); Andy Kieatiwong, San Diego, CA (US); Reiley Weeks, San Diego, CA (US); Joel Perez, Oceanside, CA (US); Alec Kochis, Oceanside, CA (US); Zachary Rogers, Oceanside, CA (US)

(21) Appl. No.: 16/140,160

(22) Filed: Sep. 24, 2018

Related U.S. Application Data
(60) Provisional application No. 62/562,118, filed on Sep. 22, 2017.

(51) Int. Cl. B24B 31/116; B24B 31/00

(52) U.S. Cl. CPC B24B 31/116; B33Y 80/00; B24B 31/006

(57) ABSTRACT

Aspects of the present disclosure are presented for techniques in removing roughness and surface anomalies in structures with internal passages and intricate external surfaces, such as structures with internal fluid passages constructed by additive manufacturing (AM), using an abrasive slurry. Post processing methods which are capable of smoothing non-uniform surface roughness within intricate fluid passages are a prerequisite to the widespread adoption of AM for complex fluid systems. In some embodiments, a mixture of abrasive powder and deionized (DI) water is used to create a viscous slurry which can then be pumped through the internal fluid passages of a workpiece until the desired surface roughness is achieved. This abrasive flow machine (AFM) is capable of smoothing a wide range of roughnesses, internal geometries, and printable materials.

### CROSS REFERENCE TO RELATED APPLICATION

This application claims priority to U.S. Provisional Application 62/562,118, filed Sep. 22, 2017, and titled “ABRASIVE FLOW MACHINE,” the disclosure of which is hereby incorporated herein by reference in its entirety and for all purposes.

### TECHNICAL FIELD

The subject matter disclosed herein generally relates to post-processing smoothing techniques. More specifically, the present disclosure relates to a methods and systems for an abrasive flow machine.

### BACKGROUND

Post processing methods for smoothing internal passages of structures typically are needed to generate a desired level of smoothness. Traditional processes often are not so refined as to handle passages of minute size and width. It is desirable to develop better techniques for smoothing internal passages, particularly for structures generated using additive manufacturing techniques.

### SUMMARY

Aspects of the present disclosure are presented for an abrasive flow machine and methods for smoothing passages of a structure.

In some embodiments, a method of an abrasive flow machine for smoothing internal passages of a structure is presented. The method may include: pumping a first slurry mixture through the internal passages of the structure for a first predetermined amount of time at a first predetermined mass flow rate, the first slurry mixture comprising a first property of grit, a first property of viscosity, and a first chemical composition; and after the first predetermined amount of time, pumping a second slurry mixture through the internal passages of the structure for a second predetermined amount of time at a second predetermined mass flow rate, the second slurry mixture comprising a second property of grit, a second property of viscosity, and a second chemical composition, wherein at least one of the second predetermined amount of time, the second mass flow rate, the second property of grit, the second property of viscosity, and the second chemical composition is different than the first predetermined amount of time, the first mass flow rate, the first property of grit, the first property of viscosity, and the first chemical composition, respectively, wherein pumping the first slurry mixture through the internal passages for the first predetermined amount of time produces a first predetermined degree of smoothness in the internal passages, and wherein pumping the second slurry mixture through the internal passages for the second predetermined amount of time produces a second predetermined degree of smoothness in the internal passages that is more smooth than the first predetermined degree of smoothness.

In some embodiments of the method, at least one of the internal passages of the structure comprises at least one smooth curve configured to change a direction of flow within said internal passage, and the pumping of the first slurry mixture and the second slurry mixture are configured to not damage the at least one smooth curve while increasing the smoothness.

In some embodiments of the method, at least one of the internal passages of the structure comprises a cross-sectional area that gradually increases or decreases in size, and the pumping of the first slurry mixture and the second slurry mixture are configured to not damage the gradually increasing or decreasing cross-sectional area while increasing the smoothness.

In some embodiments, the method further comprises determining that a predetermined performance criterion of the internal passages of the structure has not been reached. In some embodiments, the method further comprises in response to the predetermined performance criterion not being reached, generating a third slurry mixture recipe to be pumped through the internal passages of the structure for a third predetermined amount of time at a third predetermined mass flow rate, the third slurry mixture comprising a third property of grit and a third property of viscosity, and wherein at least one of the third predetermined amount of time, the third mass flow rate, the third property of grit and the third property of viscosity is different than both the first and second predetermined amount of time, both the first and second mass flow rate, both the first and second property of grit and both the first and second property of viscosity, respectively.

In some embodiments of the method, determining that the predetermined performance criterion has not been reached comprises measuring by the abrasive flow machine for pressure drop of a fluid through the internal passages of the structure.

In some embodiments of the method, the structure is additively manufactured.

In some embodiments of the method, the structure is configured to be used in industry to channel a fluid that comprises at least one different fluid dynamic property than both the first slurry mixture and the second slurry mixture.

In some embodiments of the method, the fluid used in industry comprises a Reynolds number that matches a Reynolds number of the last slurry mixture pumped through the structure.

In some embodiments, a method for generating an optimal abrasive flow processing recipe to smooth out internal passages of a structure that satisfy at least one predetermined performance criterion is presented. The method may include: generating, by at least one processor, a simulated optimized end-use model of the structure comprising sufficiently smooth internal passages that satisfy the at least one predetermined performance criterion; generating, by the at least one processor, a simulated as-built model of the structure comprising a representation of existing surface roughness of the internal passages that has not yet been smoothed out; simulating, by the at least one processor, abrasive flow through the as-built model; conducting, by the at least one processor, an optimization routine to determine the optimal abrasive flow processing recipe to achieve a desired end-use geometry of the internal passages that satisfies the at least one predetermined performance criterion, wherein the optimal abrasive flow processing recipe comprises: pumping a first slurry mixture through the internal passages of the structure for a first predetermined amount of time at a first predetermined mass flow rate, the first slurry mixture comprising a first property of grit, a first property of viscosity, and a first chemical composition; and after the first predetermined amount of time, pumping a second slurry mixture through the internal passages of the structure for a second predetermined amount of time at a second predetermined mass flow rate, the second slurry mixture comprising a second property of grit, a second property of viscosity, and a second chemical composition wherein at least one of the second predetermined amount of time, the second mass flow rate, the second property of grit, the second property of viscosity, and the second chemical composition is different than the first predetermined amount of time, the first mass flow rate, the first property of grit, the first property of viscosity, and the first chemical composition, respectively.

In some embodiments of the method, conducting, by the at least one processor, the optimization routine comprises: simulating flow on the end-use model and measuring the flow characteristics of the end-use model; and comparing the end-use model flow characteristics to flow characteristics of the simulated abrasive flow through the as-built model. In some embodiments of the method, conducting, by the at least one processor, the optimization routine further comprises: determining that the end-use model flow characteristics do not match the flow characteristics of the simulated abrasive flow through the as-built model; and modifying, by the at least one processor, the abrasive flow characteristics.

In some embodiments of the method, the optimal abrasive flow processing recipe is optimized to minimize time sufficient to satisfy the at least one performance criterion.

In some embodiments of the method, at least one of the internal passages of the structure comprises at least one smooth curve configured to change a direction of flow within said internal passage, and the pumping of the first slurry mixture and the second slurry mixture are configured to not damage the at least one smooth curve while increasing the smoothness.

In some embodiments of the method, at least one of the internal passages of the structure comprises a cross-sectional area that gradually increases or decreases in size, and the pumping of the first slurry mixture and the second slurry mixture are configured to not damage the gradually increasing or decreasing cross-sectional area while increasing the smoothness.

In some embodiments, an abrasive flow machine system for smoothing internal passages of a structure is presented. The system may include: a water reservoir; a slurry concentrate mixing tank; a first pump coupled to the reservoir; a second pump coupled to the slurry concentrate mixing tank; a slurry reservoir coupled to the first and second pumps and configured to receive water from the reservoir and a slurry mixture from the slurry concentrate mixing tank; a flow meter; a pressure transducer; a third pump coupled to the slurry reservoir, wherein the third pump is configured to be communicatively coupled to the flow meter, pressure transducer, and at least one of the internal passages of the structure; and at least one processor configured to control the flow meter and pressure transducer in order to control flow of the slurry mixture entering the structure; wherein the structure is configured to be coupled to the slurry reservoir such that the slurry mixture flowing through the internal passages of the structure is entered back into the slurry reservoir upon exiting the structure.

In some embodiments of the system, the at least one processor is further configured to control flow of the slurry mixture entering the structure using the flow meter and the pressure transducer for a predetermined amount of time at a predetermined mass flow rate, according to a recipe for smoothing the internal passages of the structure.

In some embodiments of the system, the slurry mixture is a first slurry, the predetermined amount of time is a first predetermined amount of time, the predetermined mass flow rate is a first predetermined mass flow rate, and the at least one processor is further configured to control flow of a second slurry mixture entering the structure using the flow meter and the pressure transducer for a second predetermined amount of time at a second predetermined mass flow rate, according to the recipe for smoothing the internal passages of the structure, wherein at least one of the second predetermined amount of time, the second mass flow rate, and the second slurry mixture is different than the first predetermined amount of time, the first mass flow rate, and the first slurry mixture, respectively.

In some embodiments of the system, the at least one processor is further configured to stop flow of the slurry mixture into the structure upon measuring that a predetermined performance criterion has been satisfied. In some embodiments of the system, the predetermined performance criterion comprises at least one of a predetermined measure of mass flow, a predetermined measure of pressure drop, and a predetermined drag coefficient.

### BRIEF DESCRIPTION OF THE DRAWINGS

Some embodiments are illustrated by way of example and not limitation in the figures of the accompanying drawings.

FIG. 1 shows an additively manufactured injector design containing highly intricate internal fluid passages.

FIG. 2 shows the outlines of a subjection branch of injector fluid passages.

FIG. 3 shows a CAD model of a directional fluid diverter that can also be additively manufactured.

FIG. 4 shows are series of functions fit to the closed contour of the drooped circular cross section in the ZX and ZY planes.

FIG. 5 shows a graph of the scaled surface roughness evolution as a function of normal vector angle, with a domain of +/−90 degrees.

FIG. 6 provides an illustration of a traditional extrude honing device operation that may be used to smooth out the internal passages.

FIG. 7 shows an example CAD of the proposed test coupon for material validation and parameterization.

FIG. 8 shows an example flow schematic of the abrasive flow system of the present disclosure, that may be used to perform the abrasive flow techniques described herein.

FIG. 9 shows an example abrasive flow machining process, according to some embodiments.

### DETAILED DESCRIPTION

Aspects of the present disclosure are presented for techniques in removing internal roughness and inner surface anomalies in structures with internal passages, such as structures with internal fluid passages constructed by additive manufacturing (AM), using an abrasive slurry. Post processing methods which are capable of smoothing non-uniform surface roughness within intricate fluid passages are a prerequisite to the widespread adoption of AM for complex fluid systems.

A degree of smoothness can refer to either overall surface roughness across all internal passages of a structure, a standard deviation over a section of the structure, or surface roughness of the structure azimuthally, as some ways of measuring the smoothness. There are some known techniques for boring holes in passages and for creating a general degree of smoothness of the passages. For example, a hydraulic ram has been used to press through a highly viscous slurry through an internal passage of a fuel engine to help refine the edges. However, known techniques have never accounted for smoothing out internal passages that change angles in a curved manner, or that change the cross-sectional aperture throughout the length of the passage. Using traditional techniques, curves in a passage may be damaged if the slurry used is too rough, if the force of the slurry passed through is too fast, or if the viscosity of the slurry is too dense. Furthermore, it is not known what single type of slurry, having a uniform Reynolds number, is capable of creating the desired smoothness for an entire passage that has some curved parts and some parts that gradually change in radial cross-sectional thickness. In short, traditional techniques are wholly insufficient to smooth out more complex internal passages as described.

Aspects of the present disclosure introduce a new technique for creating smooth internal passages that address these and other deficiencies. An abrasive flow machine and methods for smoothing internal passages using such an abrasive flow machine are presented that include using multiple series of slurries with different Reynolds numbers to address the varying physical characteristics of an internal passage. The different types of slurries may be composed of different materials and/or materials mixed at different concentrations.

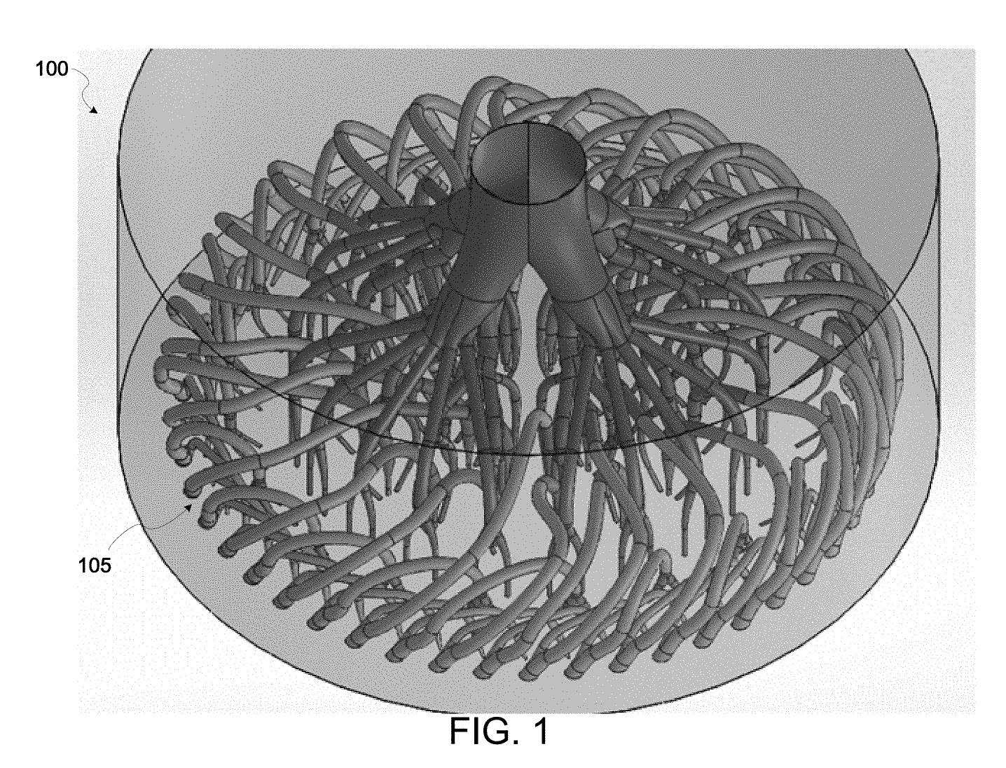

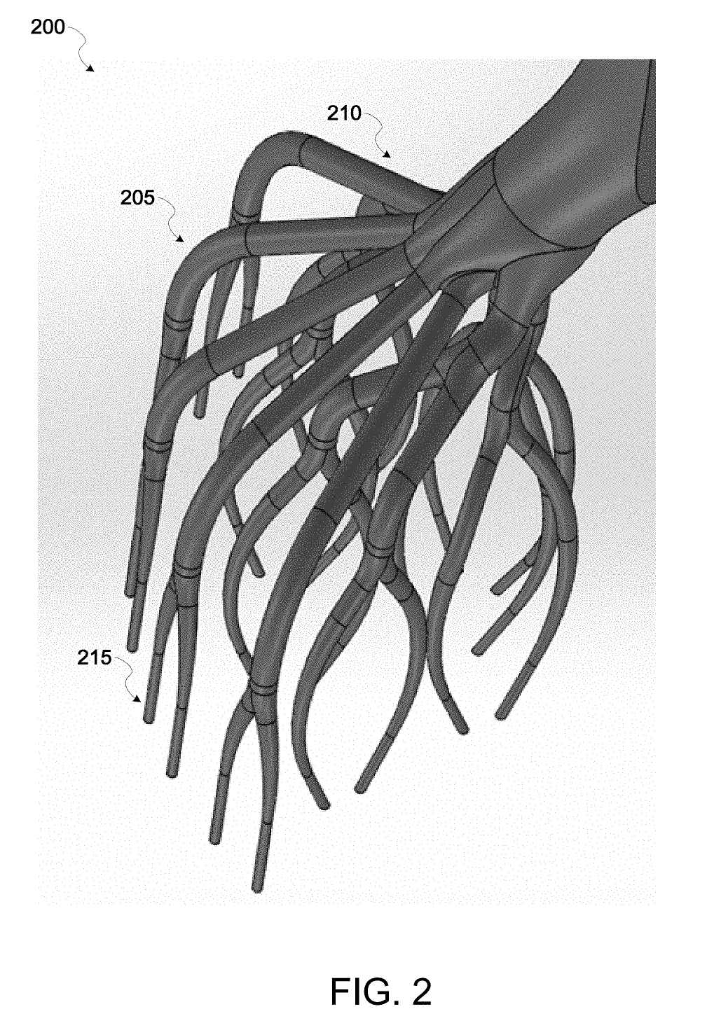

Aspects of the present disclosure also include methods for effectively “calibrating” the use of the different slurry mixtures for handling a wide array of passages, each with different angles of curvature and changing cross-sectional thickness, in order to determine a “recipe” for how to smooth out the passages. This procedure may also be used to measure and achieve a desired level of smoothness that satisfies one or more performance criteria, which other traditional techniques simply do not do. In some embodiments, the calibration techniques also overcome the challenge of determining how to create the desired level of smoothness in the internal passages using mixtures with completely different properties than the actual fluid that the internal passages are ultimately designed for. Moreover, because of the many types of curved passages and changing cross-sectional areas in multiple internal passages that need to be accounted for (see e.g., FIGS. 1 and 2 below), mere trial and error techniques using actual hydraulic presses or other actual experiments using traditional methods would be tremendously impractical. In contrast, the calibration techniques of the present disclosure include a series of tests that are then extrapolated to the intended internal passages having many different types of passage geometries, using computer calculations.

In some embodiments, a mixture of abrasive powder and deionized (DI) water is used to create a viscous slurry which can then be pumped through the internal fluid passages of a workpiece until the desired surface roughness is achieved. This abrasive flow machine (AFM) is capable of smoothing a wide range of roughnesses, internal geometries, and printable materials. In some cases, the slurry mixture may include abrasive materials and/or material moving chemicals, such as strong acids or mixtures of acids.

For high-accuracy processing, iterative simulation may be used prior to manufacturing in order to define the specific slurry grit, viscosity and flow rate recipe which is ideal for achieving the desired tolerances. Grit and viscosity variation are done automatically in some embodiments, through the addition of slurry concentrate, until the desired grit distribution and viscosity is achieved. In some embodiments, the simulation may also include defining a chemical composition of the slurry that changes for example, a degree of acidity or corrosiveness of the slurry.

By way of background, one distinct benefit of Direct Metal Laser Sintering (DMLS) is the ability to create unsupported internal passages within a component. This is accomplished by filling the cavities within the geometry with either metal powder or removable support material comprised of the same alloy used for the solid geometry.

FIGS. 1-3 show several examples of structures that may be generated using DMLS, or more generally some form of additive manufacturing, and having internal fluid passages that are not internally supported. Illustration 100 in FIG. 1 shows an additively manufactured injector design containing highly intricate internal fluid passages. Shown are the outlines of the passages, while not shown are the actual solid materials surrounding the passages that would fill in the portions now transparent for visual purposes. As can be seen, the internal passages include smooth curves that gradually change the direction of flow within the passages, such as the illustrative passage 105, though many more can be seen. This is unlike typical manufactured fluid passages that tend to have straight edges for passages that change direction at 90 degree angles, if a direction is changed at all. In addition, it can be seen that the curves in some passages change direction multiple times, such that the mass flow through such a passage will not flow such a passage at a uniform velocity or acceleration at all points through the passage. Navigating a smoothing process that accounts for these curves is not possible using conventional techniques that are designed for straight lines.

Illustration 200 of FIG. 2 shows the outlines of a subjection branch of injector fluid passages, as another example of internal passages of a structure that may be generated using additive manufacturing. Such branching passages may need to be smoothed out to offset the sintering process used to create such a structure. Again, only the outlines of the passages are shown, while in reality the space surrounding the passages would be filled in with material. As shown, not only are there passages with different curves at different angles (such as at location 205 ), but the passages have gradually decreasing cross-sectional area the further down they go. The passage at location 210 contains a moderate thickness, while the passage at location 215 contains a much more narrow thickness. It can be seen that the thickness of the passage gradually changes, eliminating any right angles or abrupt changes. Navigating a smoothing process that accounts for these narrowing or widening passages is not possible using conventional techniques that are designed for uniformly straight lines. If a single slurry mixture is used, this may result in a thicker part of the passage having a different level of smoothness than a more narrow part of the same passage.

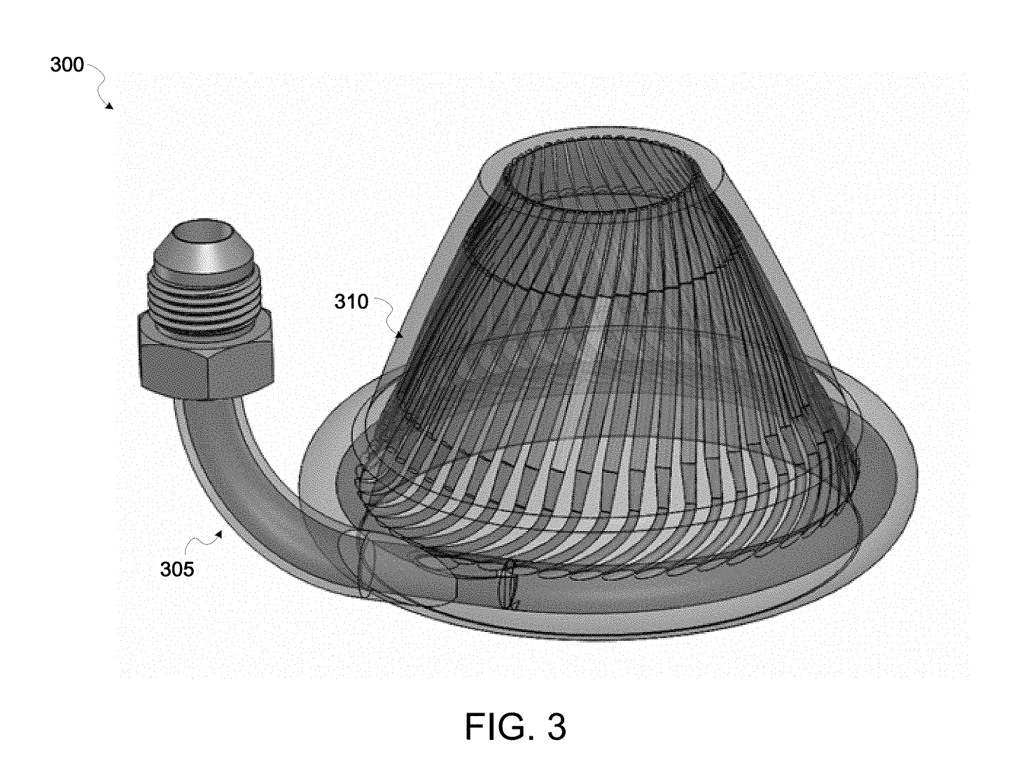

In FIG. 3, illustration 300 shows a CAD model of a directional fluid diverter that can also be additively manufactured. The internal fluid passages are shown, such as the main channel 305 that feeds the multiple diverter passages 310 travelling up the conical section, and the remaining structure is made transparent in order to isolate the fluid passages. Here, a very wide opening precedes many smaller diverter passages, leading ultimately to an even more narrow set of openings at the top of the illustration. As mentioned in FIGS. 1 and 2, the changing curvature and the widening or narrowing of the cross-sectional area of the passages cannot be easily smoothed using conventional methods that employ at most a single slurry mixture and is not intended to achieve any predetermined level of smoothness in the passages.

Each of these examples show fluid passages that would typically be manufactured as having fairly rough internal structure. To create smoother passages that may better match the modeling and better fulfill their intended functions, some method of smoothing the internal passages would be useful. New techniques such as those described herein are better suited to address these types of issues.

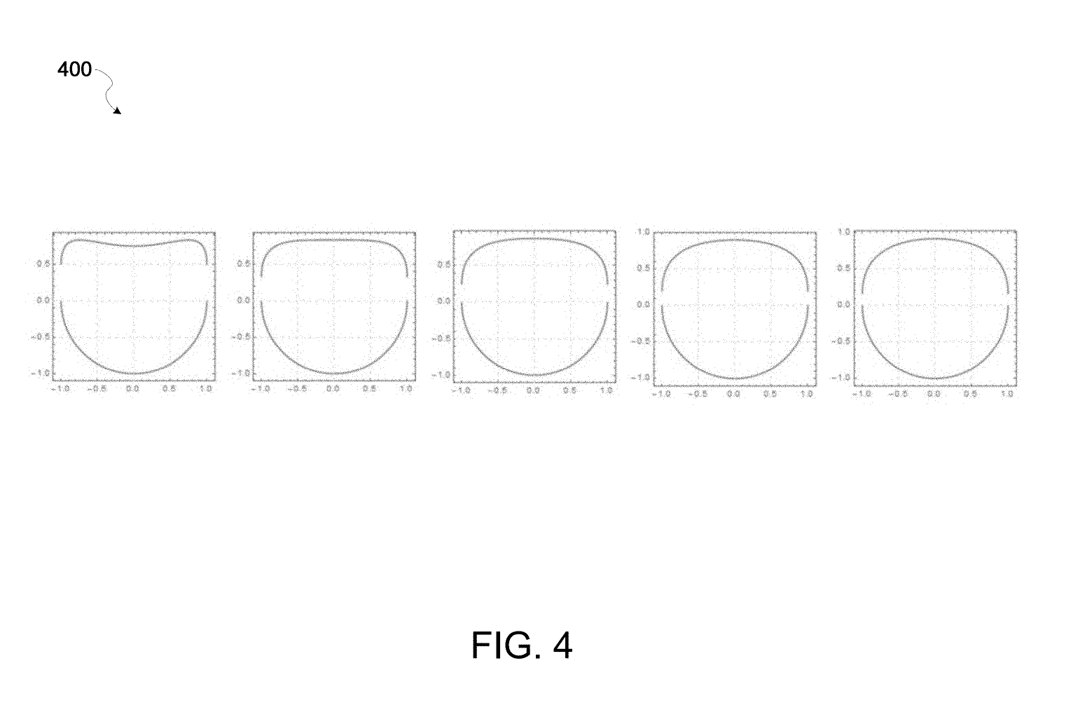

In addition, natural deformities caused by the additive manufacturing process cause additional problems. One of these is a natural “drooping” formation that typically occurs. For example, in the case of an internal passage, which extends in the plane of the print (XY), the cavity represented by the internal passage is filled with powder that is not sintered. The walls of the passage, however, are sintered. The passage is constructed by layers of metal powder 20-100 micron in thickness spread over the previously sintered XY plane layer, increasing the component height in the Z direction with each layer. While the bottom half of the passage is typically printed with little variation outside of the expected tolerances and surface roughness characteristics, the top half of the passage exhibits drooping. This drooping is caused by the unintended sintering of loose metal powder within the cavity by the sintering laser as it applies heat to the solid region above the passage. Drooping may be characterized either by a decreased channel diameter when measured from bottom to top, or by a function fit to the closed contour of the drooped circular cross section in the ZX and ZY planes, as shown illustration 400 in FIG. 4.

Non-uniform surface roughness is an inherent byproduct of powder-bed sintering techniques. Since internal passages cannot be supported by support material, layers above the passages' midpoint are printed atop unsintered powder. The result is heat conduction through the sintered material into the unsintered material, yielding a reduced interface resolution and significantly increased surface roughness.

Surface roughness typically is a function of the angle of the surface normal vector with respect to the build direction. The maximum roughness is seen in the case of overhangs, where the surface normal vector is in the −Z direction (−90 Degrees), where +Z is the build direction. The minimum surface roughness occurs where the normal vector is in the +Z direction (+90 Degrees).

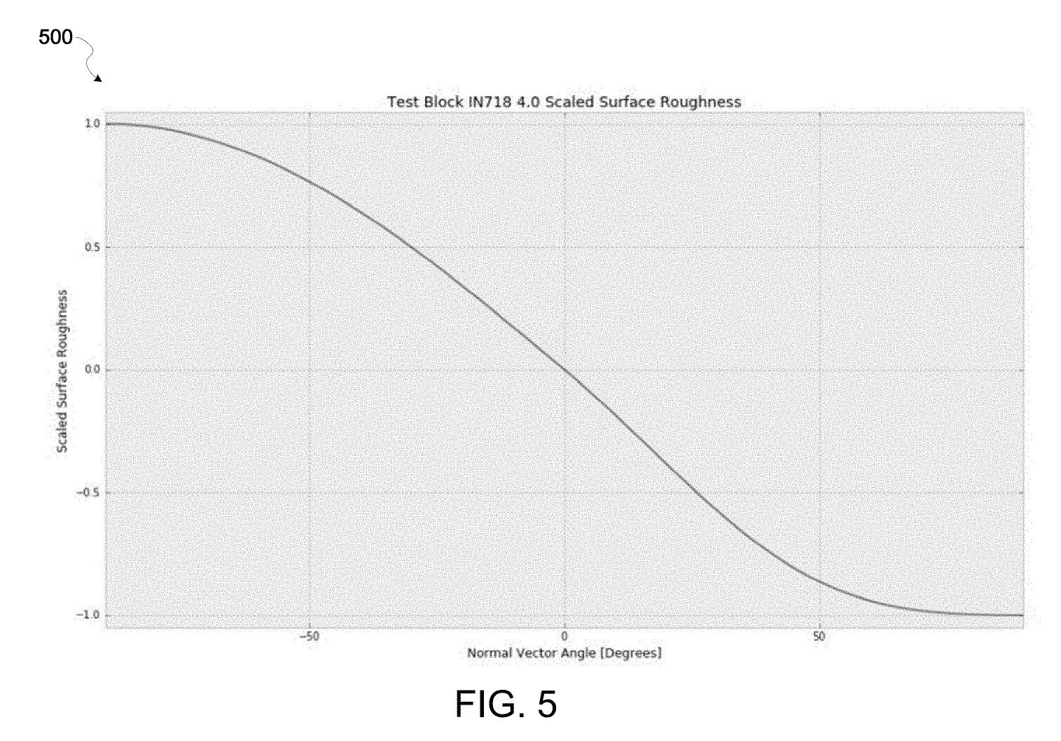

Illustration 500 in FIG. 5 shows a graph of the scaled surface roughness evolution as a function of normal vector angle, with a domain of +/−90 degrees.

To solve these types of problems, traditional post processing techniques of AM metal components is typically accomplished using any the following methods:

CNC (Computer Numeric Control)

Precision mill removes superficial material, giving a machined surface finish EDM (Electrical Discharge Machining) Wire

Conducting wire removes support material and performs surface finishing

Abrasive Sand Blasting

Reduces roughness

Chemical Etching

Chemically removes top layers of material in a uniform matter across the entire workpiece

Plasma and Laser Processing

Uses plasma or laser cutter to remove surface material or provide a specific surface finish

Vibratory Tumbler

Vibrates a vat of a coarse polishing material to deburr and reduce surface roughness

Extrude Honing

Uses a highly viscous fluid containing specifically sized grains of Aluminum Oxide, Tungsten Carbide, or Silicon Carbide and pushes the abrasive slurry through a workpiece using a hydraulic press.

Some of the aforementioned processes are even more deficient because the processes are used only for external smoothing, rather than internal smoothing procedures. Regarding the chemical etching process, the resources may be highly dangerous and corrosive, which are actually designed to strip more material away, and are not suitable for fine-tuned smoothing. In general, many of the aforementioned procedures are not suitable for highly tuned parts, and are rather better suited for large, macro-scale deburring. Moreover, none of the aforementioned procedures address the challenges of when internal passages have changing geometries, such as curves and narrowing or widening cross-sections within a single passage.

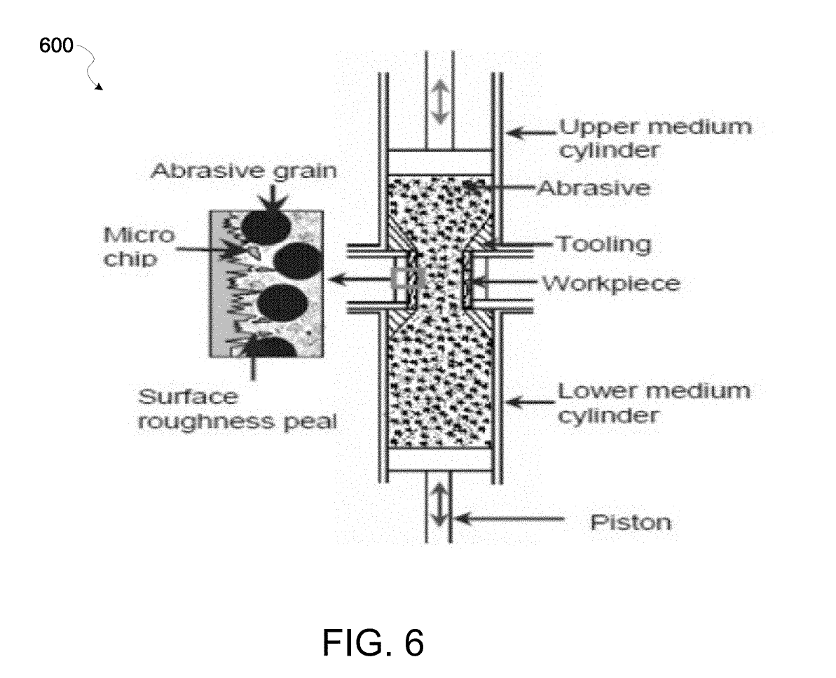

FIG. 6 provides an illustration 600 of a traditional extrude honing device operation that may be used to smooth out the internal passages. This process uses a hydraulic ram to push through a highly viscous slurry. This process is not controlled at all, due to the sheer ramming function of the hydraulic press. In addition, no measures are taken to specify what level of smoothness or head loss can be achieved. The fined-tuned specificity for certain passages would not be suitable to be run under this method. More generally, this method does not employ a closed-loop feedback process to achieve a desired performance level.

As described, traditional post processing methods similar to those listed above fall short when it comes to the processing of intricate internal passages. The proposed abrasive flow machining process of the present disclosure overcomes these shortcomings to produce the desired result.

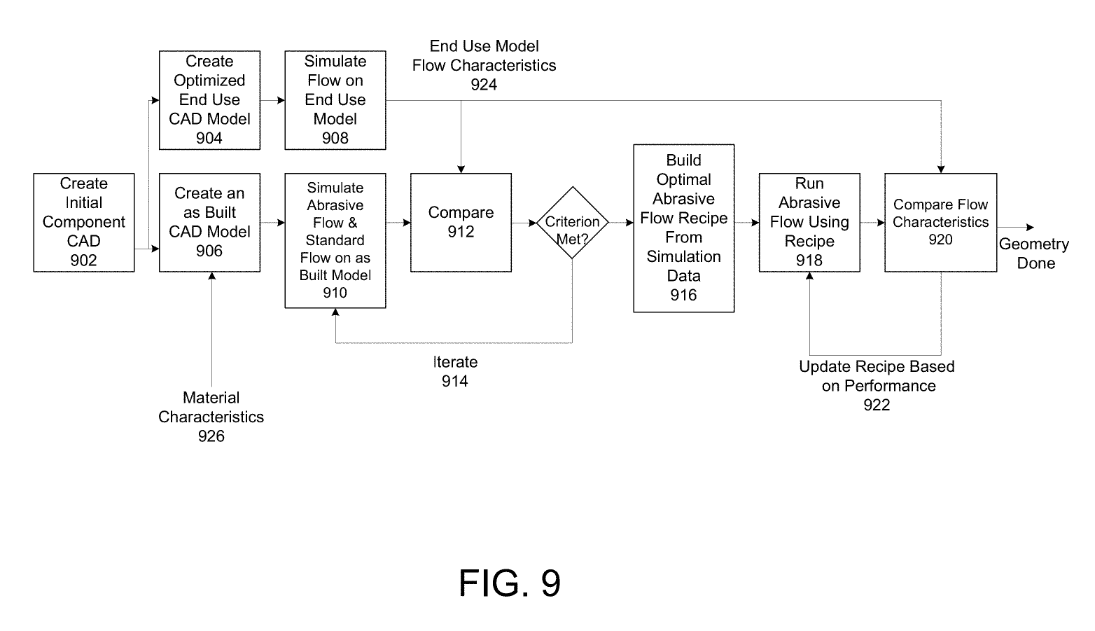

In some embodiments, the novel abrasive flow machining process involves the following steps, which are reflected in FIG. 9:
a. Create initial component CAD geometry 902 (e.g., a computer model of the structure including its internal passages);
b. Create an optimized end use component geometry 904 (e.g., a computer model of the structure with desired smoothness in its internal passages);
c. Create an as built model 906 (e.g., a computer model of the structure with imperfections included due to the manufacturing process, such as drooping, surface roughness, stray material deposits, and so forth);
   Create a CAD model with representative geometric tolerances, manufacturing anomalies (e.g. drooping) and surface roughness characteristics;
d. Simulate flow on the end use model 908. This may be used to record what the fluid dynamic properties should be when the desired performance criteria are reached
   The end use model flow characteristics are utilized in comparing 912 the abrasive flow measurements of step 910
e. Simulate the abrasive flow through the as built model 910;
   Simulate the effects of the abrasive flow to extract pressure drop, boundary layer, and flow velocity information;
   Iteratively use known data for material abrasion to update surface roughness;
   This may be run multiple times to generate multiple data points, each data point including how much material is carved out for a given velocity and viscosity. The simulation may reach an asymptotic state that describes the maximum amount of material is lost, and the data point may include how much time it takes to reach the asymptotic state to a given tolerance (e.g., 1% of the asymptotic state);
   Continue gathering more data points until enough are obtained to cumulatively reach a state of the internal passages that satisfies the performance criterion 914
f. Run optimization to determine the optimal abrasive flow processing recipe for achieving the desired end use geometry 916;
   Iteratively use known data for material abrasion (from step d) to update surface roughness iteration;
   Determine the optimal flow rate schedule with the following recipe components:
   Slurry Grit Distribution—manipulated by the source of slurry concentrate and the amount of each grit mixed into the primary hopper;
   Slurry Concentration—determined by the ratio of deionized water to slurry concentrate;
   Flow Velocity—tuned via controllable screw pump;
   Flow Duration—controlled through a system timer;
g. Send recipe to abrasive flow system;
h. Pump the slurry through the workpiece using the specified recipe and schedule 918;
i. Monitor measurement parameters to adjust flow velocity, viscosity and duration 920;
   Compare the parameters to the end use model flow characteristics
   Update the recipe as needed based on any performance deviations or anomalies 922; and
j. Re-check boundary parameters and identify variance from calibrated test pieces and codes.
k. When the performance criterion of the structure is satisfied, conclude that the smoothing process is completed

Material Validation and Parameterization

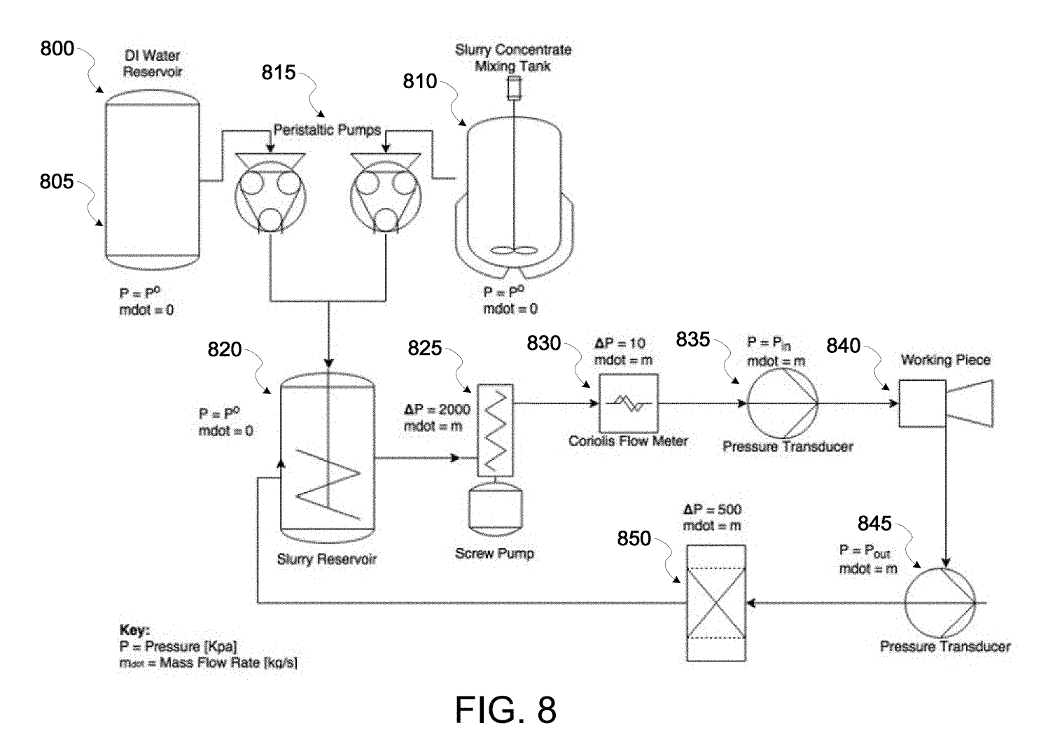

Going into more detail of the overall method described above, abrasive flow validation can be performed using the abrasive slurry system described herein. The system will qualify abrasive flow parameters to test article surface roughness erosion by recording and monitoring the upstream and downstream flow parameters and performing in process inspections methods. The abrasive slurry mixture described in the above process will be pumped through qualification articles QA1 and QA2. QA1 and QA2 may include a clamshell straight passage section with a predefined surface roughness (See FIG. 8). These surface roughnesses mimic the striation layer roughness of the AM process in the XY and XZ orientations. QA1 and QA2 will undergo a series of abrasive flow techniques and inspections to correlate surface roughness to process adjustments. Subsequent water flow pressure loss tests will link the abrasive flow process to total pressure loss and simulation results. Profilometers and digital microscope inspections will be performed over several defined time scales, mass flow rate and specific viscosities. Sensitivity and parametric evaluation of manufacturing processes will be documented, recorded and frozen.

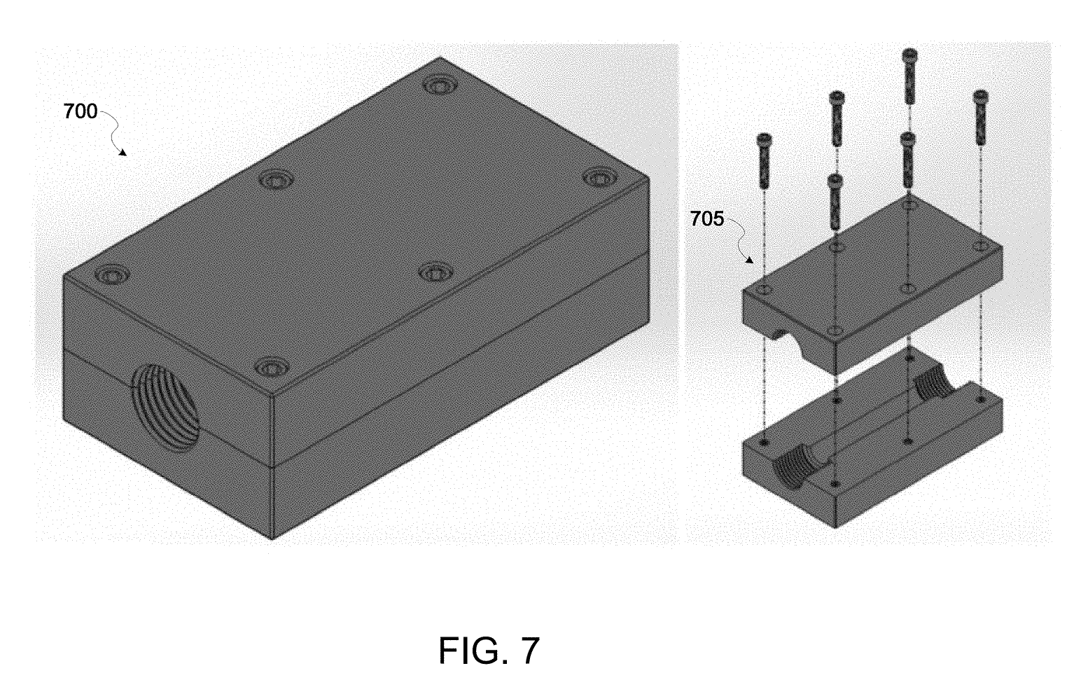

FIG. 7 shows an example CAD of the proposed test coupon 700 for material validation and parameterization. Illustration 705 shows an example of an exploded view reflecting how the test piece may be constructed. This piece, acting like a control piece, can provide data for how effective each slurry can be, with given amounts of grit, velocity, viscosity, and effects of its chemical composition on the material over a given amount of time. A given slurry may be flushed through the center of the test coupon and the effects can be measured. The test piece shown herein reflects a physical test piece used to create the empirical values of (1) a given slurry having particular physical properties as it is applied to (2) a given material. For example, when new materials are applied to the smoothing process described herein, it first needs to be understood how multiple types of slurries interact with that new material. Multiple test pieces may be built out of the new material, and a different type of slurry may be pumped through each of a different test piece to record empirical data reflecting how the new material behaves in this interaction.

While the test piece is shown to have just a straight cylindrical passage, varying pressure and relative velocity of a slurry through the straight passage is sufficient to model how the slurry would behave when encountering curves in the new material. It is known that angles of a fluid passage can be modeled by the flow of a slurry or liquid at a high pressure and/or velocity. The sharper the curved angle may correspond to more pressure and/or velocity of the slurry, for example. Using a discrete element method (DEM) simulation or a computational fluid dynamics (CFD) simulation can utilize the pressure and velocity measurements to model the slurry's effects on curves with these principles.

An additional set of QA1 and QA2 qualification articles will receive the frozen abrasive flow process and inspection method. Water flow tests can also be performed to ensure process capability, repeatability, and simulation validation.

Component Modeling

Regarding the step for component modeling, after obtaining detailed, material-specific, and feature-specific tolerancing, resolution, and surface roughness information, a CAD model representing the expected as-built part can be created. Specifically parameterized offsets may be made to the model representing the desired final geometry in order to create an as-built component with dimensions closest to those of the desired model. That is, the as-printed structure may vary from the simulated design, due to known and predictable imperfections in the manufacturing process. This can be compensated for as a result. This procedure can be extended to include post-processing, where geometric variations resulting from the aforementioned post-processing methods are taken into account when creating the CAD model to be manufactured.

In the case of AFM, the geometric offset procedure for creating optimized manufacturing models can be used in combination with as-built surface roughness data, which varies by surface normal angle relative to the build direction, and a desired roughness or head loss coefficient through the component.

Both the manufacturing model and the desired final model can be simulated in order to provide target dimensions and head loss coefficients.

As Built Model

The as-built model may then be generated, which accounts for the offsets and other known imperfections caused by the manufacturing process (e.g., 3D printing using a printer with known discrepancies).

Simulation

Regarding the step for simulating the actual process, flow simulations are performed on the target model, as well as the as-built model, taking into account non-uniform variations in surface roughness. These simulations define the target pressure drop and head loss coefficient which will later be used to determine the completion of the AFM process. As the AFM process proceeds, the sensor data can be fed back into simulations to provide more accurate as-built results. This feedback provides the basis for a system capable of modifying its operational parameters based on simulation informed need.

The simulation may include different types of viscous slurries, having different measurements of viscosity, different amounts and types of grit, and/or different types of chemical composition, run at different amounts of times and in different orders. The flow velocity may also be changed. The simulation provides a chance to adjust all these parameters for any type of different geometries. In some embodiments, the simulation may automatically develop what levels of each of these parameters may be used to be tailored to each type of geometry.

In addition to pressure drop simulations, fluid-surface interaction simulations may be performed to model the rate of abrasion caused by slurry of a specified viscosity, grit, and/or chemical composition through the specific geometry of the workpiece. Flow characteristics such as local flow velocity, boundary layer thickness, and near-surface turbulence are all taken into account. The data needed to accomplish this must be gathered from preliminary system calibration where controlled slurry velocities are pumped through test geometries possessing particular, uniform, roughness characteristics. Repeating such a study with a variety of slurry grits and the various intended workpiece materials will provide the data set necessary to simulate this process through any flow geometry.

Iterative simulation and standard optimization methods may be used to determine the ideal AFM “recipe” and schedule for the specific part. Included in Table 1, below, is an example recipe created for the post processing of Inconel 718, manufactured on an EOS m290 using DMLS. This table shows 5 steps, run at different amounts of time, with different amounts of grit, viscosity and mass flow rate, run in the particular order. This recipe may be developed by the component modeling process that determines how effective the slurry is on a particular geometry. This recipe may be developed to optimize for time, such that, for example, the first step may be applied as the most coarse process to carve out an approximate level of smoothness, and then the next step is a more refined step, and so on. In other cases, the recipe may be developed to optimize for other optimization criteria, such as minimizing material loss over the entirety of the structure, or minimizing material loss over a particular portion or surface of the structure. Furthermore, this recipe may account for certain geometries, like more drastic corners or turns in the passages, and ensures that all points in the geometry have the desired smoothness or head loss by the end of the process.

TABLE 1
Example abrasive flow schedule for post processing of
Inconel 718, manufactured using DMLS, designed by the
process of the present disclosure

| | Duration | Grit Avg. | Viscosity | Mass Flow Rate |
|---|---|---|---|---|
| Step | [hours] | [μm] | [Pa s] | [kg/s] |
| 1 | 5 | 165 | 250 | 0.2 |
| 2 | 1 | 165 | 100 | 0.5 |
| 3 | 3 | 300 | 50 | 0.5 |
| 4 | 1 | 300 | 50 | 1.5 |
| 5 | 4 | 700 | 85 | 0.75 |

In some embodiments, additional procedures are undertaken to further smooth out specific passages of the structure. For example, suppose there is a network of internal passages stemming from a single source (see e.g., FIGS. 1, 2 and 3). Some of the internal passages may reach the desired smoothness earlier than other passages, for example because the pressure drops across all of the passages are not roughly uniform and that results in some of the passages receiving more exposure to the slurry than others. To adjust for this, the passages that have reached the desired performance criterion may be restricted from further slurry flushing, thereby diverting the slurry to the passages that still need refinement. In other cases, simply more pumping through all of the passages is required until a later (or last) passage satisfies the performance criterion. Therefore, the slurry iterations end when a later (or last) passage satisfies the performance criterion, rather than simply the first (or one of the first) one. Performance criteria can be any metric reflecting a quantitative measure to describe fluid dynamics of the fluid as it interacts with the structure, such as a predetermined level of mass flow, pressure drop, or drag coefficient. The performance criteria may also include a desired shape or size of the structure or internal passages of the structure, and a measure of roughness/smoothness of the passages. Some of these may be verified by visual inspection, say for example in between slurry mixture pumping.

Each step is associated with an abrasion and smoothing coefficient, reflecting a degree of smoothness in the internal passages. The AFM system continuously measures the pressure drop across the workpiece in order to determine when the desired head loss coefficient has been reached. As previously mentioned, the present techniques herein for smoothing the passages of a structure may involve utilizing one or more slurry mixtures that are not any of the actual fluids that are intended to be channeled through the structure when the structure is used in the industry. This is unique in part because the techniques herein therefore utilize extrapolation techniques to reach the desired smoothness without relying on the actual fluid intended for use. In some embodiments, however, the last slurry mixture in the recipe should have similar fluid dynamic properties that mirror the properties of the actual fluid. For example, the last slurry mixture in the recipe may have a Reynolds number that matches the Reynolds number of the actual fluid intended for use in the structure. In this way, the recipe will inevitably mirror the behavior of what the actual fluid may behave like, to ensure the end-result properties are as desired.

System

FIG. 8 shows an example flow schematic 800 of the abrasive flow system of the present disclosure, that may be used to perform the abrasive flow techniques described herein. The abrasive flow system utilizes automated mixing and slurry preparation equipment in addition to digital flow controls and sensors. The systems sensor fusion enables it to carry out an extended AFM recipe without direct human interaction.

The slurry concentrate in the slurry concentrate mixing tank 810, containing a highly viscous, high concentration, slurry premix of a specified grit distribution can be introduced into the reservoir 820, along with DI water from the DI water reservoir 805, via peristaltic pumps 815, until the desired slurry mixture is obtained. Agitating tanks prevent the abrasive grains from falling out of solution and the digitally controlled screw pump 825 is capable of pumping a wide range of fluid viscosities at the desired flow rate while sustaining minimal abrasion to its working parts. A coriolis flow meter 830 and several pressure transducers 835 and 845 provide the fluid density and workpiece pressure drop information necessary for the feedback controls within this closed-loop system. A filter, placed inline immediately before and/or after the workpiece 840, ensures that entrained metal, originating from either the workpiece or the system components, does not clog or damage the workpiece or other components. The flow meter and pressure transducers may be controlled by one or more computer processors that follow the recipe in order to control the velocities and times that the slurries are pumped through the working piece 840.

At the end of a run using a specified grit, the reservoir may be automatically purged and refilled with the desired slurry grit, routed in from secondary or tertiary concentrate mixing tanks. Some sensors, say at the flow meter, may be installed to verify that the change in the next slurry mix achieves the desired viscosity and other measurements, for example. As one example, to transition from one step to the next (see, e.g., Table 1), a change in viscosity means a different proportion of DI water, and then the pressure applied may change the mass flow rate.

In general, the described Abrasive Flow System (AFS) of FIG. 8 is capable of completing a series of instructions corresponding to the flow recipe, as determined by the simulation optimization, or run a specified grit though a workpiece until the desired pressure drop is achieved. It can be used to remove material, or obtain a desired surface finish automatically for a wide range of materials. While this process is best suited for the optimization of metal additive manufacturing and post processing of internal fluid passages, it can be used to enhance components containing any closed feature, produced through any method. Jackets or enclosures may be included to enable the finishing of external surfaces.

In some embodiments, this process may be used in other industrial applications, such as corrosion treatment, and with different types of manufacturing. The process may be based on a target head loss or pressure drop, rather than a desired smoothness, in some embodiments. This may be measured simply by verifying the head loss or pressure drop using the desired fluid. In other cases, the desired smoothness may be measured and targeted.

In some embodiments, this process may be used to smooth out the external housing of a structure. This may be achieved by enclosing the structure with a larger casing, and then treating the external housing of the structure effectively as an internal surface when placed in the context of the larger casing. The space between the external housing and the larger casing is where the slurry mixture may be applied, and the techniques as described above may be used in this context.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A method of an abrasive flow machine for smoothing internal passages of a structure, the method comprising:
pumping a first slurry mixture through the internal passages of the structure for a first predetermined amount of time at a first predetermined mass flow rate, the first slurry mixture comprising a first property of grit, a first property of viscosity, and a first chemical composition; and
after the first predetermined amount of time, pumping a second slurry mixture through the internal passages of the structure for a second predetermined amount of time at a second predetermined mass flow rate, the second slurry mixture comprising a second property of grit, a second property of viscosity, and a second chemical composition,
wherein at least one of the second predetermined amount of time, the second mass flow rate, the second property of grit, the second property of viscosity, and the second chemical composition is different than the first predetermined amount of time, the first mass flow rate, the first property of grit, the first property of viscosity, and the first chemical composition, respectively,
wherein pumping the first slurry mixture through the internal passages for the first predetermined amount of time produces a first predetermined degree of smoothness in the internal passages, and
wherein pumping the second slurry mixture through the internal passages for the second predetermined amount of time produces a second predetermined degree of smoothness in the internal passages that is more smooth than the first predetermined degree of smoothness.

2. The method of claim 1, wherein at least one of the internal passages of the structure comprises at least one smooth curve configured to change a direction of flow within said internal passage, and the pumping of the first slurry mixture and the second slurry mixture are configured to not damage the at least one smooth curve while increasing the smoothness.

3. The method of claim 1, wherein at least one of the internal passages of the structure comprises a cross-sectional area that gradually increases or decreases in size, and the pumping of the first slurry mixture and the second slurry mixture are configured to not damage the gradually increasing or decreasing cross-sectional area while increasing the smoothness.

4. The method of claim 1, further comprising determining that a predetermined performance criterion of the internal passages of the structure has not been reached.

5. The method of claim 4, further comprising in response to the predetermined performance criterion not being reached, generating a third slurry mixture recipe to be pumped through the internal passages of the structure for a third predetermined amount of time at a third predetermined mass flow rate, the third slurry mixture comprising a third property of grit and a third property of viscosity, and wherein at least one of the third predetermined amount of time, the third mass flow rate, the third property of grit and the third property of viscosity is different than both the first and second predetermined amount of time, both the first and second mass flow rate, both the first and second property of grit and both the first and second property of viscosity, respectively.

6. The method of claim 4, wherein determining that the predetermined performance criterion has not been reached comprises measuring by the abrasive flow machine for pressure drop of a fluid through the internal passages of the structure.

7. The method of claim 1, wherein the structure is additively manufactured.

8. The method of claim 1, wherein the structure is configured to be used in industry to channel a fluid that comprises at least one different fluid dynamic property than both the first slurry mixture and the second slurry mixture.

9. The method of claim 8, wherein the fluid used in industry comprises a Reynolds number that matches a Reynolds number of the last slurry mixture pumped through the structure.

10. A method for generating an optimal abrasive flow processing recipe to smooth out internal passages of a structure that satisfy at least one predetermined performance criterion, the method comprising:
generating, by at least one processor, a simulated optimized end-use model of the structure comprising sufficiently smooth internal passages that satisfy the at least one predetermined performance criterion;
generating, by the at least one processor, a simulated as-built model of the structure comprising a representation of existing surface roughness of the internal passages that has not yet been smoothed out;
simulating, by the at least one processor, abrasive flow through the as-built model;
conducting, by the at least one processor, an optimization routine to determine the optimal abrasive flow processing recipe to achieve a desired end-use geometry of the internal passages that satisfies the at least one predetermined performance criterion, wherein the optimal abrasive flow processing recipe comprises:
pumping a first slurry mixture through the internal passages of the structure for a first predetermined amount of time at a first predetermined mass flow rate, the first slurry mixture comprising a first property of grit, a first property of viscosity, and a first chemical composition; and
after the first predetermined amount of time, pumping a second slurry mixture through the internal passages of the structure for a second predetermined amount of time at a second predetermined mass flow rate, the second slurry mixture comprising a second property of grit, a second property of viscosity, and a second chemical composition,
wherein at least one of the second predetermined amount of time, the second mass flow rate, the second property of grit, the second property of viscosity, and the second chemical composition is different than the first predetermined amount of time, the first mass flow rate, the first property of grit, the first property of viscosity, and the first chemical composition, respectively.

11. The method of claim 10, wherein conducting, by the at least one processor, the optimization routine comprises:
simulating flow on the end-use model and measuring the flow characteristics of the end-use model; and
comparing the end-use model flow characteristics to flow characteristics of the simulated abrasive flow through the as-built model.

12. The method of claim 11, wherein conducting, by the at least one processor, the optimization routine further comprises:
determining that the end-use model flow characteristics do not match the flow characteristics of the simulated abrasive flow through the as-built model; and
modifying, by the at least one processor, the abrasive flow characteristics.

13. The method of claim 10, wherein the optimal abrasive flow processing recipe is optimized to minimize time sufficient to satisfy the at least one performance criterion.

14. The method of claim 10, wherein at least one of the internal passages of the structure comprises at least one smooth curve configured to change a direction of flow within said internal passage, and the pumping of the first slurry mixture and the second slurry mixture are configured to not damage the at least one smooth curve while increasing the smoothness.

15. The method of claim 10, wherein at least one of the internal passages of the structure comprises a cross-sectional area that gradually increases or decreases in size, and the pumping of the first slurry mixture and the second slurry mixture are configured to not damage the gradually increasing or decreasing cross-sectional area while increasing the smoothness.

16. An abrasive flow machine system for smoothing internal passages of a structure, the system comprising:
a water reservoir;
a slurry concentrate mixing tank;
a first pump coupled to the reservoir;
a second pump coupled to the slurry concentrate mixing tank;
a slurry reservoir coupled to the first and second pumps and configured to receive water from the reservoir and a slurry mixture from the slurry concentrate mixing tank;
a flow meter;
a pressure transducer;
a third pump coupled to the slurry reservoir, wherein the third pump is configured to be communicatively coupled to the flow meter, pressure transducer, and at least one of the internal passages of the structure; and
at least one processor configured to control the flow meter and pressure transducer in order to control flow of the slurry mixture entering the structure;
wherein the structure is configured to be coupled to the slurry reservoir such that the slurry mixture flowing through the internal passages of the structure is entered back into the slurry reservoir upon exiting the structure.

17. The system of claim 16, wherein the at least one processor is further configured to control flow of the slurry mixture entering the structure using the flow meter and the pressure transducer for a predetermined amount of time at a predetermined mass flow rate, according to a recipe for smoothing the internal passages of the structure.

18. The system of claim 17, wherein the slurry mixture is a first slurry, the predetermined amount of time is a first predetermined amount of time, the predetermined mass flow rate is a first predetermined mass flow rate, and the at least one processor is further configured to control flow of a second slurry mixture entering the structure using the flow meter and the pressure transducer for a second predetermined amount of time at a second predetermined mass flow rate, according to the recipe for smoothing the internal passages of the structure, wherein at least one of the second predetermined amount of time, the second mass flow rate, and the second slurry mixture is different than the first predetermined amount of time, the first mass flow rate, and the first slurry mixture, respectively.

19. The system of claim 16, wherein the at least one processor is further configured to stop flow of the slurry mixture into the structure upon measuring that a predetermined performance criterion has been satisfied.

20. The system of claim 19, wherein the predetermined performance criterion comprises at least one of a predetermined measure of mass flow, a predetermined measure of pressure drop, and a predetermined drag coefficient.
